(19) United States
(12) Patent Application Publication
(10) Pub. No.: US 2025/0140878 A1
(43) Pub. Date: May 1, 2025

(54) UNIT CELL FOR FUEL CELL

(71) Applicants: Hyundai Motor Company, Seoul (KR); Kia Corporation, Seoul (KR)

(72) Inventor: Duk Hoon Kwon, Hwaseong-si (KR)

(21) Appl. No.: 18/608,014

(22) Filed: Mar. 18, 2024

(30) Foreign Application Priority Data
Oct. 27, 2023 (KR) 10-2023-0145392

(51) Int. Cl. H01M 8/0273; H01M 8/0258; H01M 8/1004; H01M 8/2483

(52) U.S. Cl. CPC H01M 8/0273; H01M 8/0258; H01M 8/2483; H01M 8/1004

(57) ABSTRACT

An embodiment unit cell for a fuel cell includes an anode separator, a cathode separator, a frame disposed between the anode separator and the cathode separator, a membrane electrode assembly, and a pair of gas diffusion layers coupled to first and second sides of the membrane electrode assembly, respectively. The frame includes a plurality of films laminated together, a through hole disposed in a central portion of the frame, a manifold hole disposed in an edge portion of the frame, wherein the manifold hole is configured to allow a fluid to flow therethrough, and a slit disposed in a first plurality of the plurality of films, the slit extending from the manifold hole toward the through hole and cut to define a fluid flow path, wherein the membrane electrode assembly and the pair of gas diffusion layers are disposed in the through hole in the frame.

### CROSS-REFERENCE TO RELATED APPLICATIONS

This application claims the benefit of Korean Patent Application No. 10-2023-0145392, filed on Oct. 27, 2023, which application is hereby incorporated herein by reference.

### TECHNICAL FIELD

The present disclosure relates to a unit cell for a fuel cell.

### BACKGROUND

A fuel cell is a type of power generator for converting chemical energy contained in fuel into electrical energy by electrochemically reacting in a stack, and it may not only supply driving power for industrial, domestic, building, aviation, and vehicles but it also may be used for supplying the power of small electronics such as a portable device, and in recent years, its use area is gradually expanding to a high-efficiency clean energy source.

The unit cell of a typical fuel cell has a membrane electrode assembly (MEA) located at the innermost side, and the membrane electrode assembly is composed of a polymer electrolyte membrane capable of transporting hydrogen protons, and an anode and cathode, which are electrodes disposed so that hydrogen and oxygen may react on both surfaces of the electrolyte membrane.

In addition, a gas diffusion layer (GDL) is laminated on the outer portion of the membrane electrode assembly, that is, the outer portion where the anode and the cathode are located, and a separator on which a flow field is formed to supply the fuel and discharge water generated by reaction is located on the outer portion of the gas diffusion layer.

A fuel cell stack is configured by laminating a plurality of unit cells having the above configuration in series in order to generate a desired level of output from the fuel cell. The fuel cell stack has an end plate coupled to the outermost sides of the unit cells in order to support and fix the plurality of unit cells.

Meanwhile, an electricity generating assembly (EGA) which integrates the membrane electrode assembly and the gas diffusion layer has been conventionally produced and used for convenience in the airtightness maintenance and lamination process of the unit cell.

In addition, research has recently been conducted on frames supporting EGA. The frame is made of engineering plastic (EP) to ensure heat resistance and is molded through an injection method. However, the frame is formed to be thin, but its structure is complex, so when it is molded through an injection method, there is a problem that some areas are not molded to have the desired structure or are distorted due to thickness deviation or pressure deviation.

The discussion of the related art is given to gain a sufficient understanding of the related art of embodiments of the present invention only, and it should not be interpreted as acknowledgement that the related art belongs to technologies that are well-known to those of ordinary skill in the art.

### SUMMARY

Embodiments of the present disclosure can solve problems in the art, and an embodiment provides a unit cell for a fuel cell including a frame with a structure that can minimize thickness deviation or pressure deviation.

The technical objects achievable by embodiments of the present disclosure are not limited to the technical objects mentioned above, and other technical objects not mentioned may be clearly understood by those skilled in the art from the following descriptions.

A unit cell for a fuel cell according to embodiments of the present disclosure may comprise an anode separator, a cathode separator, and a frame which is disposed between the anode separator and the cathode separator and is formed by laminating a plurality of films, wherein a through hole through which a membrane electrode assembly and a gas diffusion layer are coupled is formed in a central portion of the frame, a manifold hole through which fluid flows is formed in an edge portion of the frame, and a slit extending from the manifold hole toward the through hole and cut to form a fluid flow path is formed in some of the plurality of films.

For example, in the through hole of the frame, a seating surface may be formed extending from at least one of the plurality of films toward the through hole along an edge of the through hole, and the membrane electrode assembly and the gas diffusion layer may be coupled through the seating surface formed in the through hole.

For example, the gas diffusion layers may be coupled to both sides of the membrane electrode assembly, the gas diffusion layer coupled to one side of the membrane electrode assembly may be seated on the seating surface together with the membrane electrode assembly, and the gas diffusion layer coupled to the other side may be formed to be smaller in size than the membrane electrode assembly and disposed in the through hole in a state not seated on the seating surface.

For example, a plurality of the slits may be formed in some of the plurality of films by cutting the some of the plurality of films, and the plurality of the slits may be formed in parallel and spaced apart from each other along an edge of the manifold hole.

For example, the frame may include a first slit and second slit formed in different areas, the first slit may be formed in some of the plurality of films, and the second slit may be formed in other films except for the some of the plurality of films.

For example, the first slit and the second slit may be formed in different manifold holes.

For example, the first slit may be formed in some of the films provided on a side in contact with the anode separator among the plurality of films, and the second slit may be formed in another film provided on a side in contact with the cathode separator among the plurality of films.

For example, a gasket may be installed on a side of each of the anode separator and the cathode separator that does not face the frame, and the first slit and the second slit may be formed by extending from the manifold hole of the frame to a point located posterior to a corresponding point where the gasket of each of the anode separator and the cathode separator is mounted.

For example, the frame may be formed by surface adherence of a first film in contact with the anode separator and a second film in contact with the cathode separator, the first slit may be formed in the first film, and the second slit may be formed in the second film.

For example, the first slit may be formed in an outermost film of the plurality of films on the side in contact with the anode separator, and the second slit may be formed in an outermost film of the plurality of films on a side in contact with the cathode separator.

For example, a forming portion may be formed on the anode separator and the cathode separator at points corresponding to the first slit and the second slit, respectively, so that the forming portion and each slit together may form a flow path.

For example, a width direction length of the forming portion formed on each of the anode separator and the cathode separator may be formed to be the same as or different from a width direction length of the first slit and the second slit.

For example, the frame may be provided with a plurality of the first slits and a plurality of the second slits spaced apart from each other in parallel, and the anode separator and the cathode separator may have a plurality of the forming portions at points corresponding to the plurality of first slits and the plurality of second slits.

For example, width direction lengths of the plurality of the forming portions may be formed to be the same as or different from each other, respectively.

For example, the forming portion is formed to protrude toward a side that does not face the frame of each of the anode separator and the cathode separator.

For example, a reaction surface may be formed in a central portion of a side corresponding to the frame of each of the anode separator and the cathode separator, the manifold hole through which fluid flows may be formed at each edge portion, and the forming portion may be formed to extend from the manifold hole of each of the anode separator and the cathode separator toward the reaction surface.

For example, a gasket may be installed on a side that does not face the frame of each of the anode separator and the cathode separator, and the forming portion may be formed by extending from the manifold hole of each of the anode separator and the cathode separator only to a point where the gasket is installed.

According to the above, in the unit cell for a fuel cell of embodiments of the present disclosure, a seating surface is formed in the through hole of the frame, and the membrane electrode assembly and gas diffusion layer are seated on the seating surface, thereby minimizing the occurrence of a step between the frame and the gas diffusion layer.

In addition, by configuring the frame with a plurality of films and forming the detailed structure of the frame through film cutting, the frame can be molded similar to that molded through the injection method, reducing the occurrence of distortion, and easily forming the desired structure.

In addition, the slit is formed by cutting some of the plurality of films, and the inlet/outlet and path through which the fluid flows through the slit and the forming portion formed on the separator are formed, thereby improving the fluid transferability into the separator.

In addition, by forming the slit by cutting the film, the cross-sectional area of the inlet/outlet through which the fluid flows can be freely adjusted.

The effects of embodiments of the present disclosure are not limited to the above-described effects, and other effects which are not described herein will become apparent to those skilled in the art from the following description.

### BRIEF DESCRIPTION OF THE DRAWINGS

FIG. 1 is an exploded perspective view showing a unit cell for a fuel cell according to an embodiment of the present disclosure.

FIG. 2 is a diagram showing one side of a frame according to an embodiment of the present disclosure.

FIG. 3 is a cross-sectional view taken along line I-I of FIG. 2.

FIG. 4 is a diagram showing one side of a frame provided on an anode separator according to an embodiment of the present disclosure.

FIG. 5 is a diagram showing the other side of a frame provided on a cathode separator according to an embodiment of the present disclosure.

FIG. 6 is a diagram showing a cathode separator of a unit cell for a fuel cell according to an embodiment of the present disclosure.

FIG. 7 is a cross-sectional view taken along line II-II of FIG. 6.

FIG. 8 is a cross-sectional view taken along line III-III in FIG. 6.

FIG. 9 is a diagram showing an anode separator of a unit cell for a fuel cell according to an embodiment of the present disclosure.

FIG. 10 is a cross-sectional view taken along line IV-IV of FIG. 9.

FIG. 11 is a cross-sectional view taken along line V-V of FIG. 9.

FIGS. 12 to 15 are perspective views showing a cathode separator of a unit cell for a fuel cell according to another embodiment of the present disclosure.

### DETAILED DESCRIPTION OF ILLUSTRATIVE EMBODIMENTS

In describing the embodiments of the disclosure, a detailed description of known arts will be omitted if it is determined that the detailed description of the known arts can obscure the embodiments of the disclosure. In addition, the accompanying drawings are used to help easily understand the embodiments of the disclosure, and it should be understood that embodiments presented herein are not limited by the accompanying drawings. As such, it should be understood that the embodiments of the disclosure include all changes, equivalents, and substitutes included in the spirit and technical scope of the embodiments of the present disclosure.

Although the terms including an ordinal number such as first, second, etc. can be used for describing various elements, the structural elements are not restricted by the terms. The terms are used merely for the purpose of distinguishing an element from the other elements.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The singular forms are intended to include the plural forms as well, unless the context clearly indicates otherwise.

It will be further understood that the terms “comprises,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof in advance.

Hereinafter, the embodiments of the disclosure will be described in detail with reference to the accompanying drawings. However, identical or similar components will be assigned the same reference numbers regardless of figure numbers, and duplicate descriptions thereof will be omitted.

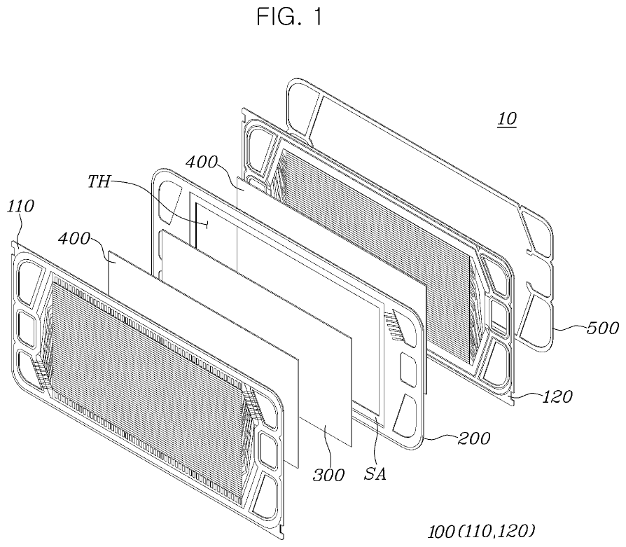

First, a unit cell for a fuel cell according to an embodiment of the present disclosure will be described with reference to FIG. 1.

FIG. 1 is an exploded perspective view showing a unit cell for a fuel cell according to an embodiment of the present disclosure.

Referring to FIG. 1, a unit cell 10 for a fuel cell according to an embodiment of the present disclosure may include an anode separator 110, a cathode separator 120, a frame 200, a membrane electrode assembly 300, and a gas diffusion layer 400. Each component is described below.

The unit cell 10 for a fuel cell may be a component forming a fuel cell stack. For example, the unit cell 10 may include an anode (positive electrode), a cathode (negative electrode), and an electrolyte membrane located between the anode and the cathode. Specifically, the electrolyte membrane is located between the anode and the cathode, enabling the conduction of hydrogen ions while electrically separating the anode and the cathode. The anode and the cathode may be coated with a catalyst that ionizes hydrogen and oxygen, and the anode and the cathode may be joined to the electrolyte membrane and exist as one unit. This is referred to as a membrane electrode assembly (MEA) 300.

The gas diffusion layer (GDL) 400 may be provided on both sides of the membrane electrode assembly 300, and the gas diffusion layer 400 may include an anode gas diffusion layer provided on the anode side of the membrane electrode assembly 300 and a cathode gas diffusion layer provided on the cathode side of the membrane electrode assembly 300.

As the gas diffusion layer 400 is provided, the transfer and distribution of hydrogen and oxygen to the membrane electrode assembly 300 can be smoothly performed. The anode gas diffusion layer can diffuse hydrogen, and the cathode gas diffusion layer can diffuse air.

A separator 100 may be coupled to the structure in which the membrane electrode assembly 300 and the gas diffusion layer 400 are combined, thereby forming one unit cell 10. The separator 100 may electrically connect the unit cells 10, and a flow path through which hydrogen and oxygen moves may be formed in the separator 100. For example, the anode separator 110 may be provided on the anode side of the membrane electrode assembly 300, and the cathode separator 120 may be provided on the cathode side of the membrane electrode assembly 300.

A frame 200 may be disposed between the anode separator 110 and the cathode separator 120. Conventionally, the frame 200 has been molded through an injection method and made of engineering plastic (EP). However, it was impossible to form a fine structure in the frame 200 through the injection method. In embodiments of the present disclosure, the frame 200 may be formed by laminating a plurality of films instead of injection molding. That is, the frame 200 according to an embodiment of the present disclosure may be formed by laminating a plurality of films.

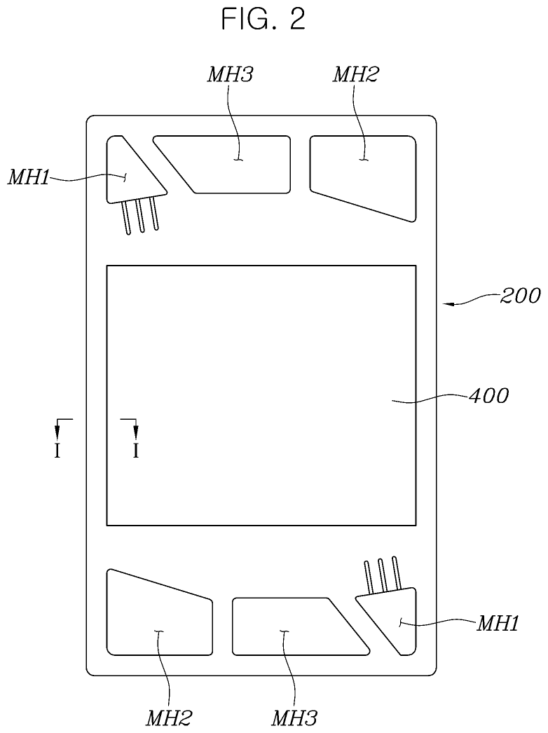

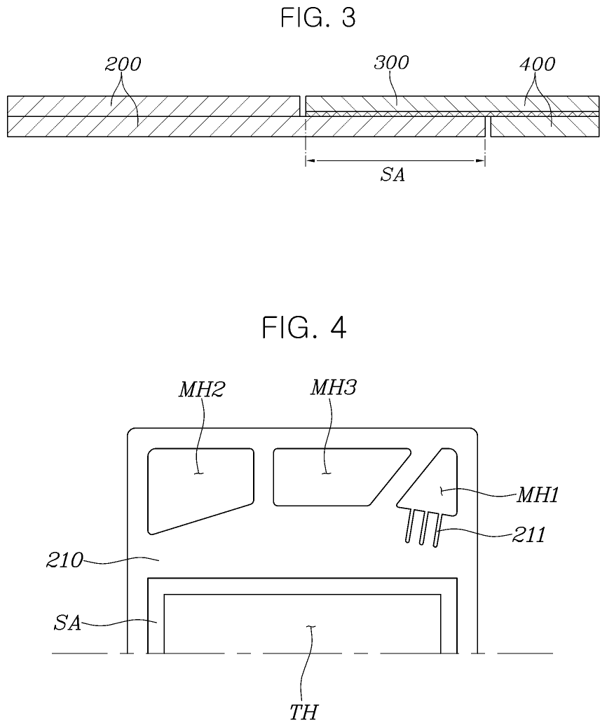

Meanwhile, a through hole TH may be formed in the center of the frame 200, and the membrane electrode assembly 300 and the gas diffusion layer 400 may be coupled to the frame 200 through the through hole TH. To this end, a seating surface SA where the membrane electrode assembly 300 and the gas diffusion layer 400 are coupled may be formed in the through hole TH. For example, the seating surface SA may be formed by extending toward the through hole TH from at least one of the plurality of films along the edge of the through hole TH. This will be explained with reference to FIGS. 2 and 3.

FIG. 2 is a diagram showing one side of a frame according to an embodiment of the present disclosure. FIG. 3 is a cross-sectional view taken along line I-I of FIG. 2.

First, referring to FIG. 2, the membrane electrode assembly 300 and the gas diffusion layer 400 may be combined in the through hole TH formed in the center of the frame 200. As the gas diffusion layer 400 is adhered to both sides of the membrane electrode assembly, the gas diffusion layer 400 may be exposed in the area corresponding to the through hole TH on both sides of the frame 200. For example, in FIG. 2, it is assumed that the anode gas diffusion layer is exposed on one side of the frame 200.

Referring to FIG. 3, the seating surface SA extending toward the through hole TH may be formed on one of the plurality of films forming the frame 200. In FIG. 3, for convenience of explanation, it is assumed that the frame 200 is formed of two films. However, this is an example and the number of films is not necessarily limited thereto.

In addition, the membrane electrode assembly 300 and the gas diffusion layer 400 may be coupled to the formed seating surface SA. For example, the gas diffusion layer 400 is coupled to both sides of the membrane electrode assembly 300, and the gas diffusion layer 400 coupled to one side of the membrane electrode assembly 300 may be seated on the seating surface SA together with the membrane electrode assembly 300. The gas diffusion layer 400 coupled to the other side of the membrane electrode assembly 300 may be formed in a smaller size than the membrane electrode assembly 300 and may be disposed in the through hole TH in a state not seated on the seating surface SA.

As the seating surface SA is formed in the through hole TH of the frame 200, and the membrane electrode assembly 300 and the gas diffusion layer 400 are seated on the seating surface SA, the gas diffusion layer 400 may form a height level similar to that of the frame 200 and may be coupled to the frame 200.

In other words, the thickness of the unit cell 10 can be prevented from increasing by minimizing the level difference between the frame 200 and the gas diffusion layer 400.

Meanwhile, referring again to FIG. 2, a manifold hole through which fluid flows may be formed at the edge of the frame 200, and the manifold hole may be divided into a plurality of holes depending on the type of fluid. For example, the frame 200 may be formed with a first manifold hole MH1 through which hydrogen flows, a second manifold hole MH2 through which air flows, and a third manifold hole MH3 through which coolant flows.

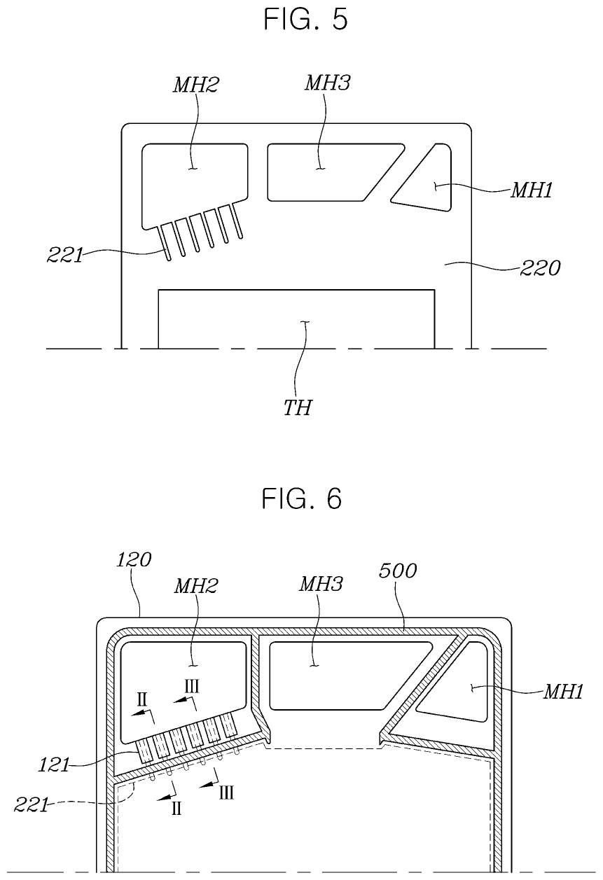

In addition, the frame 200 according to an embodiment of the present disclosure is formed of a plurality of films, and a fine structure formed in the frame 200 may be formed by cutting each film. For example, some of the plurality of films forming the frame 200 may have slits extending from the manifold hole toward the through hole TH and cut to form a fluid flow path. In addition, a plurality of slits may be formed in some of the plurality of films by cutting the films, and the plurality of slits may be formed in parallel and spaced apart from each other along the edge of the manifold hole. This will be explained through FIGS. 4 and 5.

FIG. 4 is a diagram showing one side of a frame provided on an anode separator according to an embodiment of the present disclosure. FIG. 5 is a diagram showing the other side of a frame provided on a cathode separator according to an embodiment of the present disclosure.

First, it is assumed that the frame 200, which will be described below, is formed of a plurality of films, for example, two films. This is only an assumption for convenience of explanation, and apparently, the configuration of the frame 200 is not necessarily limited thereto.

The frame 200 may be formed of a first film 210 in contact with the anode separator 110 and a second film 220 in contact with the cathode separator 120, and the first film 210 and the second film 220 may be formed by surface adhesion to each other.

FIG. 4 is a diagram of the first film 210 in contact with the anode separator 110. Referring to FIG. 4, the plurality of manifold holes MH1, MH2, MH3 may be formed in the first film 210, and a first slit 211 extending from one of the manifold holes (e.g., MH1) toward the through hole TH and cut may be formed in the first film 210. When the number of films forming the frame 200 exceeds two, the first slit 211 may be formed in some of the films provided on the side in contact with the anode separator 110 among the plurality of films. In particular, the first slit 211 may be formed in the outermost film on the side in contact with the anode separator 110 among the plurality of films.

In addition, the first film 210 may be formed by cutting a plurality of first slits 211, and the plurality of first slits 211 may be formed in parallel and spaced apart from each other along the edge of one manifold hole (e.g., MH1).

In addition, FIG. 5 is a diagram of the second film 220 in contact with the cathode separator 120. Referring to FIG. 5, a plurality of manifold holes MH1, MH2, MH3 may be formed in the second film 220, and a second slit 221 extending from one of the manifold holes (e.g., MH1) toward the through hole TH and cut may be formed in the second film 220. When the number of films forming the frame 200 exceeds two, the second slit 221 may be formed in some of the films provided on the side in contact with the cathode separator 120 among the plurality of films. In particular, the second slit 221 may be formed in the outermost film on the side in contact with the cathode separator 120 among the plurality of films.

In addition, the second film 220 may be formed by cutting a plurality of second slits 221, and the plurality of second slits 221 may be formed in parallel and spaced apart from each other along the edge of one manifold hole (e.g., MH2).

The first film 210 and the second film 220 are surface adhered to each other to form the frame 200. As can be seen in FIGS. 4 and 5, the areas where the first slit 211 and the second slit 221 are formed are different.

In other words, the frame 200 includes the first slits 211 and the second slits 221 formed in different areas, and when the frame 200 is formed of a plurality of films, some of the plurality of films may include the first slit 211 and other films except the some films among the plurality of films may include the second slit 221. In addition, in relation to this, the first slit 211 and the second slit 221 may be formed on different manifold holes.

Hereinafter, the fluid flow path formed through the slits 211 and 221 described above and fluid flow will be described with reference to FIGS. 6 to 11. However, to facilitate understanding, the cathode separator 120 of the unit cell 10 will be described first, and then the anode separator 110 will be described.

First, the cathode separator 120 of the unit cell 10 will be described with reference to FIGS. 6 to 8.

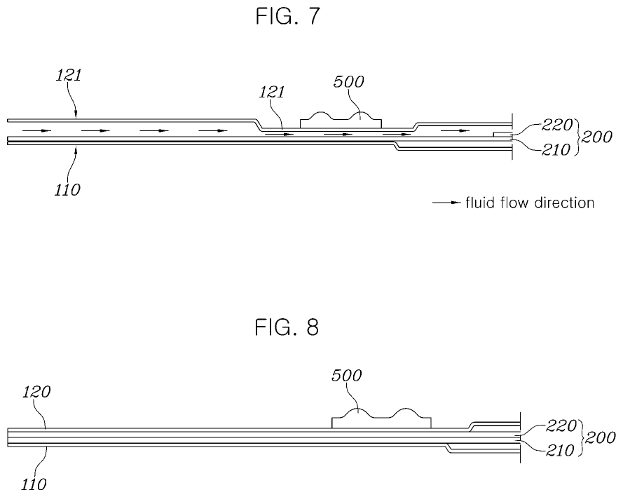

FIG. 6 is a diagram showing a cathode separator of a unit cell for a fuel cell according to an embodiment of the present disclosure. FIG. 7 is a cross-sectional view taken along line II-II of FIG. 6. FIG. 8 is a cross-sectional view taken along line III-III in FIG. 6.

Referring to FIG. 6, the cathode separator 120 may be coupled to one side of the frame 200, for example, to the second film 220. Accordingly, a forming portion 121 may be formed in the cathode separator 120 at a point corresponding to the second slit 221 formed in the second film 220. If the frame 200 is provided with the plurality of second slits 221 spaced apart from each other in parallel, the cathode separator 120 may also be formed with the plurality of forming portions 121 at points corresponding to the plurality of second slits 221.

In addition, the forming portion 121 may be formed to protrude toward a side of the cathode separator 120 that does not face the frame 200. Due to the shape of the forming portion 121 formed on the cathode separator 120, the forming portion 121 and the second slit 221 can form a fluid flow path.

However, the area where the forming portion 121 is formed on the cathode separator 120 and the area where the second slit 221 is formed on the frame 200 may be limited. For example, a gasket 500 may be installed on the side of the cathode separator 120 that does not face the frame 200, that is, the outer surface of the cathode separator 120. As the gasket 500 is mounted on the cathode separator 120, the forming portion 121 formed on the cathode separator 120 may be formed so as not to interfere with the area where the gasket 500 is mounted.

For example, a reaction surface (not shown) may be formed in the center of the side of the cathode separator 120 corresponding to the frame 200, and the manifold holes MH1, MH2, MH3 through which fluid flows may be formed on the edge of the cathode separator 120. Since the forming portion 121 must be formed to correspond to the second slit 221 formed in the frame 200, it may be formed extending from the same manifold hole MH2 as the manifold hole (e.g., MH2) where the second slit 221 is formed, toward the reaction surface. However, as the gasket 500 is mounted on the cathode separator 120, the forming portion 121 may be formed to extend from the manifold hole MH2 only to the point where the gasket 500 is mounted.

On the other hand, the frame 200 is joined to the inner surface of the cathode separator 120, and the second slit 221 formed in the frame 200 may be formed regardless of whether the gasket 500 is installed or not. That is, the second slit 221 may extend from the manifold hole MH2 of the frame 200 to a point located posterior to the point corresponding to the point where the gasket 500 of the cathode separator 120 is mounted.

The fluid flow due to the difference in shape between the forming portion 121 and the second slit 221 will be described with reference to FIGS. 7 and 8.

Referring to FIG. 7, it can be seen that the forming portion 121 is formed to protrude only to the front of the point where the gasket 500 is mounted. Due to the protruding forming portion 121, the fluid flowing along the manifold hole MH2 can easily flow into the inside of the forming portion 121, and the inflow fluid flows from front to rear along the forming portion 121. In this case, when viewed at the point where the gasket 500 is installed, it can be seen that a space as large as a sheet of film is formed between the anode separator 110 and the cathode separator 120. This may be the space formed by the second slit 221 extending to a point posterior to the point where the gasket 500 of the second film 220 located on the side facing the cathode separator 120 among the films 210, 220 forming the frame 200 is mounted. Due to this space, the fluid flowing in through the forming portion 121 can flow smoothly from the front to the rear, and the transferability of the fluid can be improved.

Meanwhile, referring to FIG. 8, the forming portion 121 is formed to protrude only up to the front of the point where the gasket 500 is mounted, so that since the frame 200 does not form a space at the point where the gasket 500 is installed, the inflow fluid cannot be delivered to the rear. That is, the fluid is essentially introduced through the forming portion 121, but a selective fluid flow is formed that delivers or does not deliver the introduced fluid to the rear depending on the formation position of the second slit 221 of the frame 200.

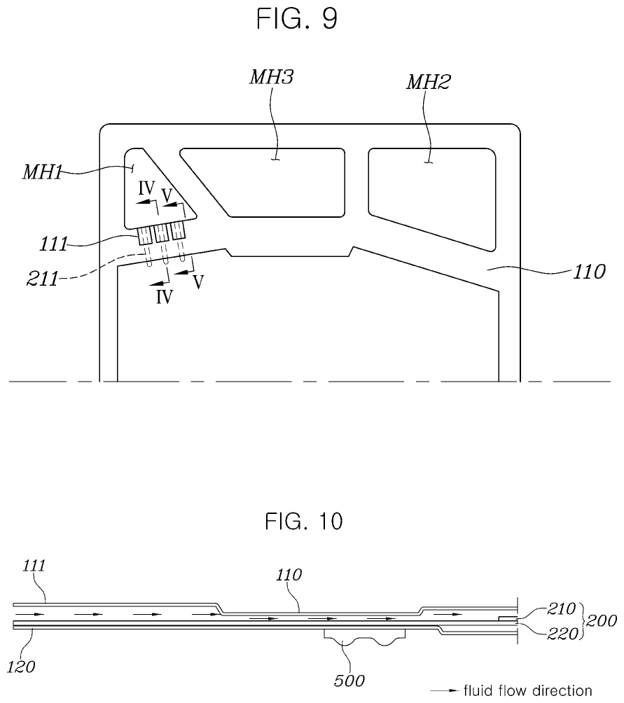

Next, the anode separator 110 of the unit cell 10 will be described with reference to FIGS. 9 to 11.

FIG. 9 is a diagram showing an anode separator of a unit cell for a fuel cell according to an embodiment of the present disclosure. FIG. 10 is a cross-sectional view taken along line IV-IV of FIG. 9. FIG. 11 is a cross-sectional view taken along line V-V of FIG. 9.

Referring to FIG. 9, the anode separator 110 may be coupled to the other side of the frame 200, for example, to the first film 210. Accordingly, a forming portion 111 may be formed in the anode separator 110 at a point corresponding to the first slit 211 formed in the first film 210. If the frame 200 is provided with the plurality of first slits 211 spaced apart from each other in parallel, the anode separator 110 may also be formed with the plurality of forming portions 111 at points corresponding to the plurality of first slits 211.

In addition, the forming portion 111 may be formed to protrude toward a side of the anode separator 110 that does not face the frame 200. Due to the shape of the forming portion 111 formed on the anode separator 110, the forming portion 111 and the first slit 211 can form a fluid flow path.

However, as described above with respect to FIG. 6, the area where the forming portion 111 is formed on the anode separator 110 and the area where the first slit 211 is formed on the frame 200 may be limited. For example, the gasket 500 may be installed on the side of the anode separator 110 that does not face the frame 200, that is, the outer surface of the anode separator 110. As the gasket 500 is mounted on the anode separator 110, the forming portion 111 formed on the anode separator 110 may be formed so as not to interfere with the area where the gasket 500 is mounted.

For example, a reaction surface (not shown) may be formed in the center of the side of the anode separator 110 corresponding to the frame 200, and the manifold holes MH1, MH2, MH3 through which fluid flows may be formed on the edge of the anode separator 110. Since the forming portion 111 must be formed to correspond to the first slit 211 formed in the frame 200, it may be formed extending from the same manifold hole MH1 as the manifold hole (e.g., MH1) where the first slit 211 is formed, toward the reaction surface. However, as the gasket 500 is adhered to the cathode separator 120, the forming portion 111 may be formed to extend from the manifold hole MH1 only to the point where the gasket 500 is mounted.

On the other hand, the frame 200 is joined to the inner surface of the anode separator 110, and the first slit 211 formed in the frame 200 may be formed regardless of whether the gasket 500 is adhered or not. That is, the first slit 211 may extend from the manifold hole MH1 of the frame 200 to a point located posterior to the point corresponding to the point where the gasket 500 of the anode separator 110 is adhered.

The fluid flow due to the difference in shape between the forming portion 111 and the second slit 221 will be described with reference to FIGS. 10 and 11.

Referring to FIG. 10, it can be seen that the forming portion 111 is formed to protrude only to the front of the point where the gasket 500 is mounted. Due to the protruding forming portion 111, the fluid flowing along the manifold hole MH1 can easily flow into the inside of the forming portion 111, and the inflow fluid flows from front to rear along the forming portion 111. In this case, when viewed at the point where the gasket 500 is installed, it can be seen that a space as large as a sheet of film is formed between the anode separator 110 and the cathode separator 120. This may be the space formed by the first slit 211 extending to a point posterior to the point where the gasket 500 of the first film 210 located on the side facing the anode separator 110 among the films 210, 220 forming the frame 200 is adhered. Due to this space, the fluid flowing in through the forming portion 111 can flow smoothly from the front to the rear, and the transferability of the fluid can be improved.

Meanwhile, referring to FIG. 11, in a section where the forming portion 111 is not formed, the frame 200 may block the inflow of fluid, and as a result, the fluid cannot be delivered to the rear. That is, not only can fluid be selectively introduced through the forming portion 111, but a selective fluid flow that either delivers or does not deliver the fluid to the rear can be formed.

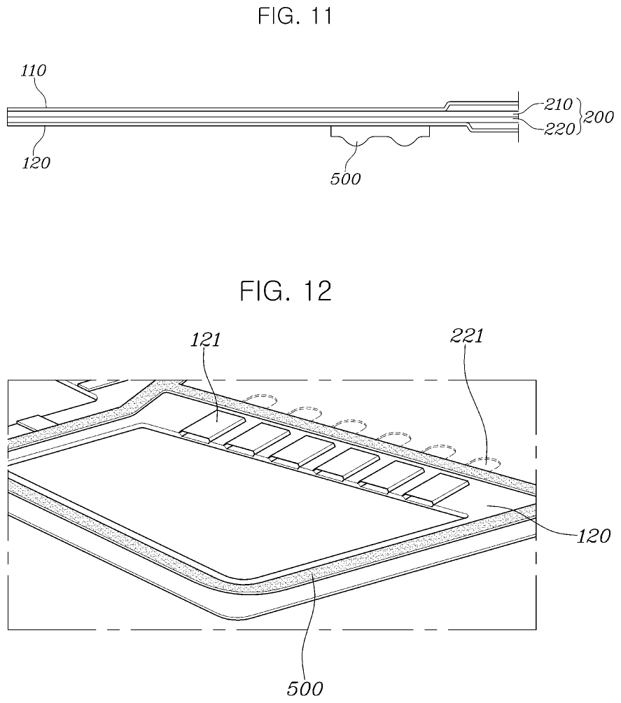

On the other hand, the forming portion 111 formed on the anode separator 110 and the forming portion 121 formed on the cathode separator 120 may be formed to be the same as or different from the width direction lengths of the first slit 211 and the second slit 221 whose width direction lengths respectively correspond to the forming portions 111, 121. In addition, when the forming portion 111 formed on the anode separator 110 and the forming portion 121 formed on the cathode separator 120 are each formed in plural numbers, each of the plurality of forming portions may be formed to have the same or different lengths in the width direction. This is explained with reference to FIGS. 12 to 15.

FIGS. 12 to 15 are perspective views showing a cathode separator of a unit cell for a fuel cell according to another embodiment of the present disclosure.

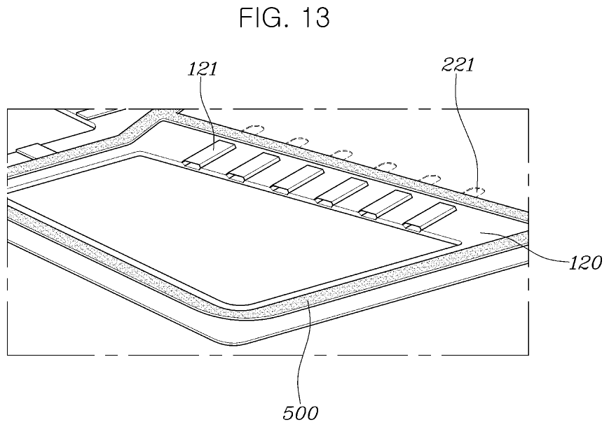

Referring to FIGS. 12 and 13, the width direction length of the forming portion 121 formed on the cathode separator 120 may be formed to be identical to the width direction length of the second slit 221 of the frame 200 corresponding to the forming portion 121. That is, the width direction length of the forming portion 121 and the width direction length of the second slit 221 may both be formed wide or narrow.

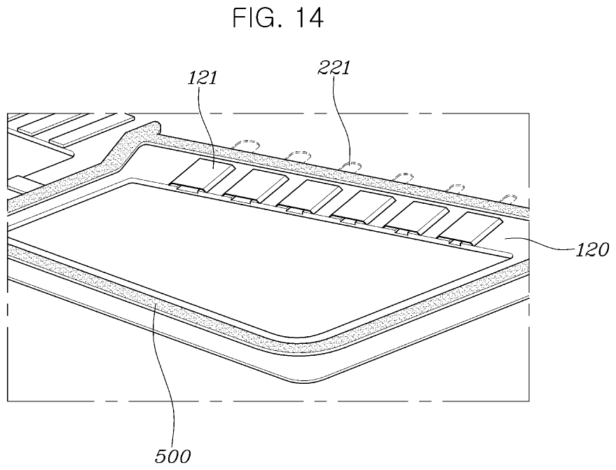

Meanwhile, referring to FIG. 14, the width direction length of the forming portion 121 formed on the cathode separator 120 may be fixed, and the width direction length of the second slit 221 of the frame 200 may be formed to gradually increase or decrease.

Through this, the flow rate or amount of fluid flowing into the cathode separator 120 can be adjusted by freely adjusting the cross-sectional area through which the fluid is introduced or flows.

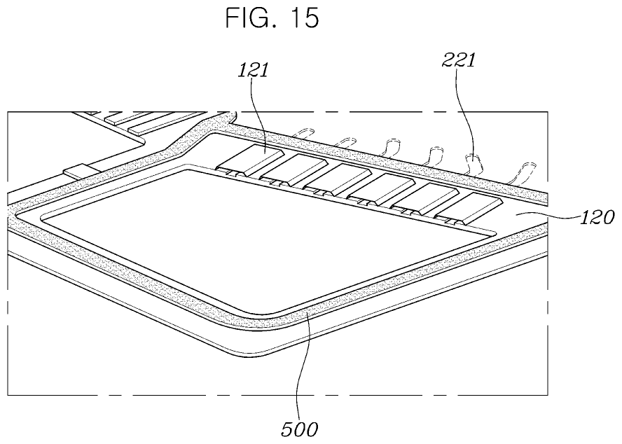

On the other hand, referring to FIG. 15, the width direction length of the forming portion 121 formed on the cathode separator 120 and the width direction length of the second slit 221 of the frame 200 may be fixed, and the shape of the end portion of the second slit 221 extending to the rear may be changed. Through this, when fluid flows in along the fluid flow path formed by the forming portion 121 and the second slit 221, the inflow fluid can flow smoothly to the rear arrival point.

According to the above, in the unit cell for a fuel cell of embodiments of the present disclosure, a seating surface is formed in the through hole of the frame, and the membrane electrode assembly and the gas diffusion layer are seated on the seating surface, thereby minimizing the occurrence of a step between the frame and the gas diffusion layer.

In addition, by constructing the frame with a plurality of films and forming the detailed structure of the frame through film cutting, the frame can be molded similar to that molded through the injection method, reducing the occurrence of distortion, and easily forming the desired structure.

In addition, the slit is formed by cutting some of the plurality of films, and the inlet/outlet and path through which the fluid flows through the slit and the forming portion formed on the separator are formed, thereby improving the fluid transferability into the separator.

In addition, by forming the slit by cutting the film, the cross-sectional area of the inlet/outlet through which the fluid flows can be freely adjusted.

Although the exemplary embodiments of the present disclosure have been disclosed for illustrative purposes, those skilled in the art will appreciate that various improvements and modifications are possible, without departing from the scope and spirit of the embodiments of the disclosure as disclosed in the accompanying claims.

The above detailed description should not be construed as restrictive in any respect and should be considered illustrative. The scope of the embodiments of the present disclosure should be determined by reasonable interpretation of the appended claims, and all changes within the equivalent scope of the embodiments of the present disclosure are included in the scope of the embodiments of the present disclosure.

What is claimed is:

1. A unit cell for a fuel cell, the unit cell comprising:
an anode separator;
a cathode separator;
a frame disposed between the anode separator and the cathode separator, the frame comprising:
a plurality of films laminated together;
a through hole disposed in a central portion of the frame;
a manifold hole disposed in an edge portion of the frame, wherein the manifold hole is configured to allow a fluid to flow therethrough; and
a slit disposed in a first plurality of the plurality of films, the slit extending from the manifold hole toward the through hole and cut to define a fluid flow path; and
a membrane electrode assembly and a pair of gas diffusion layers coupled to first and second sides of the membrane electrode assembly, respectively, wherein the membrane electrode assembly and the pair of gas diffusion layers are disposed in the through hole in the frame.

2. The unit cell of claim 1, further comprising a seating surface in the through hole of the frame extending from a film of the plurality of films toward the through hole along an edge of the through hole, wherein the membrane electrode assembly is disposed on the seating surface.

3. The unit cell of claim 2, wherein a first gas diffusion layer of the pair of gas diffusion layers coupled to the first side of the membrane electrode assembly is seated on the seating surface together with the membrane electrode assembly, and a second gas diffusion layer of the pair of gas diffusion layers coupled to the second side of the membrane electrode assembly is smaller in size than the membrane electrode assembly and is disposed in the through hole in a state of not being seated on the seating surface.

4. The unit cell of claim 1, wherein the slit comprises a plurality of slits disposed in the first plurality of the plurality of films, the slits are disposed in parallel and spaced apart from each other along an edge of the manifold hole, and the slits comprise cuts in the first plurality of the plurality of films.

5. A unit cell for a fuel cell, the unit cell comprising:
an anode separator;
a cathode separator;
a frame disposed between the anode separator and the cathode separator, the frame comprising:
a plurality of films laminated together;
a through hole disposed in a central portion of the frame;
a manifold hole disposed in an edge portion of the frame, wherein the manifold hole is configured to allow a fluid to flow therethrough; and
a first slit disposed in a first film of the plurality of films, the first slit extending from the manifold hole toward the through hole and cut to define a fluid flow path;
a second slit disposed in a different area than the first slit and in a second film of the plurality of films different from the first film of the plurality of films; and
a membrane electrode assembly and a pair of gas diffusion layers coupled to first and second sides of the membrane electrode assembly, respectively, wherein the membrane electrode assembly and the pair of gas diffusion layers are disposed in the through hole in the frame.

6. The unit cell of claim 5, wherein the first slit and the second slit extend from different manifold holes.

7. The unit cell of claim 5, wherein the first film of the plurality of films is disposed on a first side of the frame in contact with an inner side of the anode separator, and the second film of the plurality of films is disposed on a second side of the frame in contact with an inner side of the cathode separator.

8. The unit cell of claim 7, further comprising a pair of gaskets respectively disposed on an outer side of each of the anode separator and the cathode separator, wherein the first slit and the second slit extend from the manifold hole of the frame to a point located posterior to a corresponding point where each gasket of the pair of gaskets is disposed.

9. The unit cell of claim 7, wherein the first film is coupled to the second film by surface adherence.

10. The unit cell of claim 7, wherein the first film comprises a plurality of first film layers laminated together and the second film comprises a plurality of second film layers laminated together, the first slit is cut in an outermost film layer of the plurality of first film layers on an outer side in contact with the anode separator, and the second slit is cut in an outermost film layer of the plurality of second film layers on an outer side in contact with the cathode separator.

11. The unit cell of claim 7, further comprising forming portions disposed on the anode separator and the cathode separator at points corresponding to the first slit and the second slit, respectively, such that the forming portions together with each of the first slit and the second slit define the fluid flow paths.

12. The unit cell of claim 11, wherein a width direction length of the forming portions is equal to a width direction length of the first slit and the second slit.

13. The unit cell of claim 11, wherein a width direction length of the forming portions is different from a width direction length of the first slit and the second slit.

14. The unit cell of claim 11, wherein the first slit is provided in plural and spaced apart from each other in parallel, the second slit is provided in plural and spaced apart from each other in parallel, the anode separator has a plurality of the forming portions at points corresponding to the first slits, and the cathode separator has a plurality of the forming portions at points corresponding to the second slits.

15. The unit cell of claim 14, wherein width direction lengths of the forming portions are equal to each other.

16. The unit cell of claim 14, wherein width direction lengths of the forming portions are different from each other.

17. The unit cell of claim 11, wherein the forming portions respectively protrude toward an outer side of the anode separator and an outer side of the cathode separator that do not face the frame.

18. The unit cell of claim 11, wherein reaction surfaces are respectively disposed in a central portion of an inner side of each of the anode separator and the cathode separator facing the frame, the manifold hole through is disposed at each edge portion, and the forming portions extend from the manifold hole of each of the anode separator and the cathode separator toward the reaction surface.

19. The unit cell of claim 18, further comprising a pair of gaskets respectively disposed on outer sides of each of the anode separator and the cathode separator not facing the frame, wherein the forming portions extend from the manifold hole of each of the anode separator and the cathode separator only to points where the gaskets are disposed.
